(19) United States
(12) Patent Application Publication
(10) Pub. No.: US 2016/0040666 A1
(43) Pub. Date: Feb. 11, 2016

(54) Rotary Injection Valve Systems and Apparatus and Methods for Operating the Same

(71) Applicant: TORAD ENGINEERING, LLC, Cumming, GA (US)

(72) Inventors: Gregory T. Kemp, Alpharetta, GA (US); Joseph S. Orosz, Woodstock, GA (US); Craig R. Bradshaw, Buford, GA (US)

(21) Appl. No.: 14/762,565

(22) PCT Filed: Jan. 24, 2014
(86) PCT No.: PCT/US2014/012992

§ 371 Date: Jul. 22, 2015

Related U.S. Application Data
(60) Provisional application No. 61/756,077, filed on Jan. 24, 2013.

(51) Int. Cl. F04C 15/06; F04C 29/12; F04C 2/344; F04C 18/344; F16K 11/065; F16K 31/04

(52) U.S. Cl. CPC F04C 15/06; F16K 11/065; F16K 31/047; F04C 2/344; F04C 18/344; F04C 29/12

(57) ABSTRACT

Implementations described herein comprise fluid rotary injection valve systems and apparatus configured to selectively allow a working fluid to pass from one chamber into another where the fluid flow occurs at predetermined times and flow rates. Such fluid rotary injection valve systems can be useful in connection with rotational equipment and particularly for high speed rotational equipment operating with differential internal and external process pressures.

### BACKGROUND OF THE INVENTION

### The Field of the Invention

Implementations described herein relate generally to fluid rotary injection valves systems and apparatus useful, for example, in connection with rotational equipment and particularly with rotational equipment operating with differential internal and external process pressures.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In aspects of the present disclosure, a fluid rotary injection valve system is provided that is configured to allow or prevent the fluid flow from one chamber to another in a selective and dynamic fashion.

In aspects of the present disclosure, the rotary injection valve can be configured to allow a working fluid to pass from one chamber into another where the fluid flow occurs selectively with regard to flow rates and over timed intervals so as to achieve desired performance from a pump, compressor, or other fluidic device.

In yet other aspects of the disclosure, a rotary injection valve further comprising a moveable valve barrel can be configured to be controlled by a cam profile provided in a moving component of a rotary fluidic device such that the at least one outlet passage provided in the valve barrel line up at least partially with the corresponding at least one passage provided in a housing such that fluid flow is achieved between two zones.

Additional features and advantages of exemplary implementations of the invention will be set forth in the description which follows, and in part will be obvious from the description, or can be learned by the practice of such exemplary implementations. The features and advantages of such implementations can be realized and obtained by means of the instruments and combinations particularly pointed out in the appended claims. These and other features will become more fully apparent from the following description and appended claims, or can be learned by the practice of such exemplary implementations as set forth hereinafter.

### BRIEF DESCRIPTION OF THE DRAWINGS

The accompanying drawings, which are incorporated in and constitute a part of this specification, illustrate aspects and together with the description, serve to explain the principles of the methods and systems.

FIG. 1 is an exploded view of a spool rotary compressor incorporating a valve bore for receiving a rotary injection valve.

FIG. 2 is partial cut-away view showing the rotary injection valve and its actuating pin and guide cam.

FIG. 3 is a detail view of the rotary injection valve barrel.

FIG. 4 is a view of the slotted guide cam.

FIG. 5 is a cutaway view of the assembled rotary injection valve installed in a spool compressor.

FIG. 6 is an isometric view of a peripheral cam.

FIG. 7 is an exploded view of a modulated valve.

FIG. 8 is a view of a modulated rotary injection valve assembly.

FIG. 9 is a view of a modulated rotary injection valve assembled into a spool compressor.

FIG. 10 is a view of a modulated rotary injection valve in its closed position within a spool compressor assembly.

FIG. 11 is a view of a modulated rotary injection valve in a partially open position within a spool compressor assembly.

FIG. 12 is a graph showing the cyclical flow achieved through the rotary injection valve of the invention.

FIG. 13 is an exploded view of rotary valve as installed in a rotary spool expander

FIG. 14 is a cutaway view of a modulated rotary valve installed in a rotary spool expander.

### DETAILED DESCRIPTION OF THE PREFERRED ASPECTS

The present invention can be understood more readily by reference to the following detailed description, examples, drawing, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein, while still obtaining the beneficial results described herein. It will also be apparent that some of the desired benefits described herein can be obtained by selecting some of the features described herein without utilizing other features. Accordingly, those who work in the art will recognize that many modifications and adaptations to the present invention are possible and can even be desirable in certain circumstances and are a part described herein. Thus, the following description is provided as illustrative of the principles described herein and not in limitation thereof.

Reference will be made to the drawings to describe various aspects of one or more implementations of the invention. It is to be understood that the drawings are diagrammatic and schematic representations of one or more implementations, and are not limiting of the present disclosure. Moreover, while various drawings are provided at a scale that is considered functional for one or more implementations, the drawings are not necessarily drawn to scale for all contemplated implementations. The drawings thus represent an exemplary scale, but no inference should be drawn from the drawings as to any required scale.

In the following description, numerous specific details are set forth in order to provide a thorough understanding described herein. It will be obvious, however, to one skilled in the art that the present disclosure can be practiced without these specific details. In other instances, well-known aspects of rotary injection valves have not been described in particular detail in order to avoid unnecessarily obscuring aspects of the disclosed implementations.

As used in the specification and the appended claims, the singular forms “a,” “an” and “the” include plural referents unless the context clearly dictates otherwise.

As used herein, the term “fluid” can refer to any non-solid such as a liquid, a gas, a slurry, a vapor, a two phase state material, or other non-solid matter.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

“Optional” or “optionally” means that the subsequently described event or circumstance can or cannot occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these cannot be explicitly disclosed, each is specifically contemplated and described herein, for all methods and systems. This applies to all aspects of this application including, but not limited to, steps in disclosed methods. Thus, if there are a variety of additional steps that can be predefined it is understood that each of these additional steps can be predefined with any specific aspect or combination of aspects of the disclosed methods.

Implementations described herein are directed toward fluid rotary injection valves useful, for example, in connection with rotational equipment and particularly for rotational equipment operating with differential internal and external process pressures. In some aspects, the present disclosure can relate to an improvement in the rotary injection valve system for rotary vane machines and fluid devices, and more particularly vane pumps, compressors, and rotary fluid displacement devices including those described in U.S. Pat. No. 8,113,805, filed Jul. 11, 2008, the entire contents of which are hereby incorporated by reference.

Reference will now be made to the drawings to describe various aspects of one or more implementations of the invention. It is to be understood that the drawings are diagrammatic and schematic representations of one or more implementations, and are not limiting of the present disclosure. Moreover, while various drawings are provided at a scale that is considered functional for one or more implementations, the drawings are not necessarily drawn to scale for all contemplated implementations. The drawings thus represent an exemplary scale, but no inference should be drawn from the drawings as to any required scale.

In the following description, numerous specific details are set forth in order to provide a thorough understanding of the subject matter described herein. However, one skilled in the art will appreciate that the present disclosure can be practiced without these specific details. In other instances, well known aspects of rotary injection valves have not been described in particular detail in order to avoid unnecessarily obscuring aspects of the disclosed implementations. Furthermore, the present disclosure describes a rotary injection valve in terms of a compressor assembly solely for the sake of clarity. As will be apparent to one skilled in the art in light of the present disclosure, such rotary injection valves can also be configured for use in, for example and without limitation, both vapor and liquid injection applications, economizer circuits, pumps, expanders, vacuum pumps, and the like.

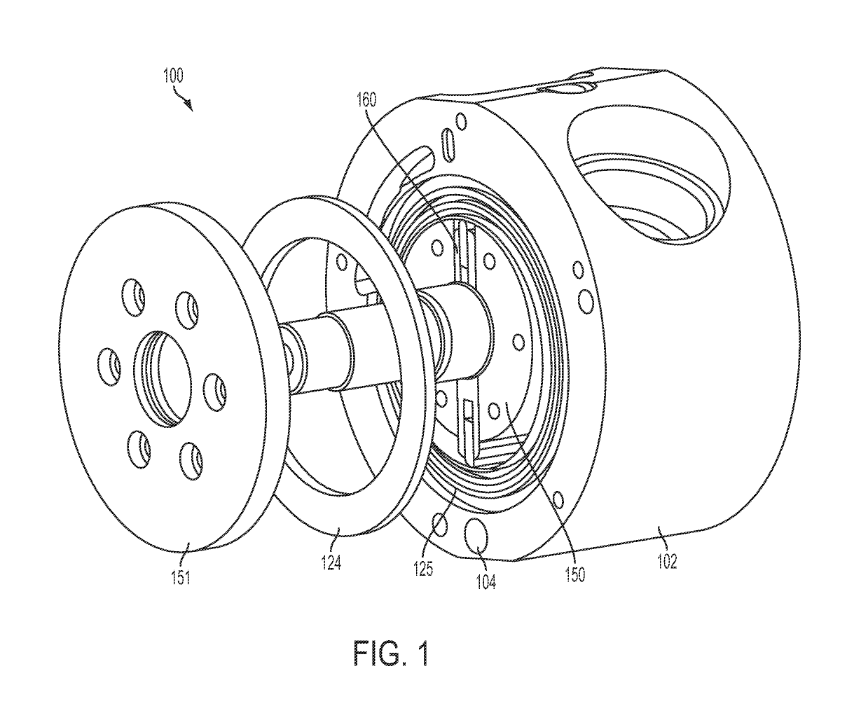

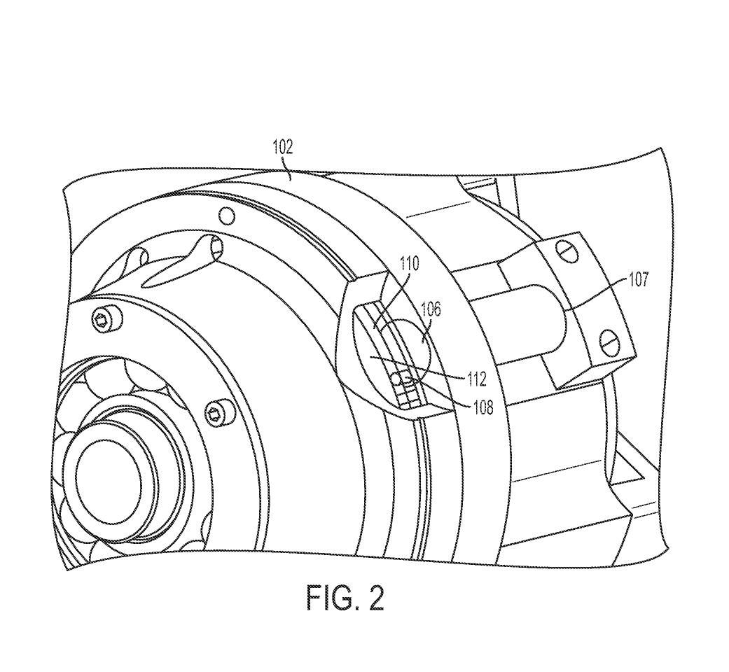

Turning now to FIGS. 1 and 2, one implementation of one aspect of a rotary injection valve that can be adapted for use for either liquid or vapor injection is illustrated. Here, a spool compressor 100 comprises a housing 102 having a valve bore 104 defined therein. As illustrated in FIG. 2, a rotary injection valve barrel 106 having a longitudinal axis 107 can be rotatably received in the valve bore 104 provided in housing 102. The valve barrel 106 further comprises a guide pin 108 located parallel to but in a non-concentric location with respect to the valve barrel longitudinal axis 107 such that, in operation, a lateral force applied to guide pin 108 will cause rotation of valve barrel 106 about said axis.

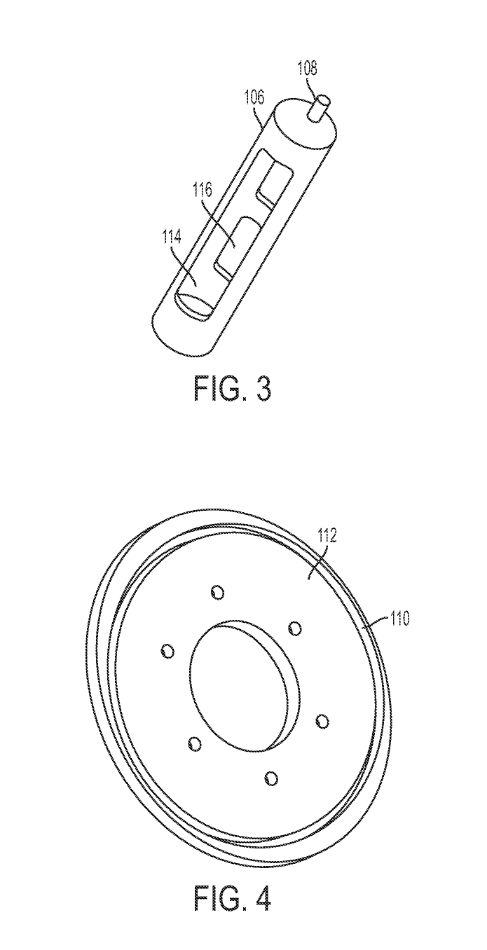

As illustrated in to FIGS. 3 and 4, rotation of the valve barrel 106 about its longitudinal axis 107 can be caused by the selective engagement of guide pin 108 into a guide cam slot 110 provided in guide cam 112. (The guide cam 112 and guide cam slot 110 can also be seen in FIG. 2.) In light of the present disclosure, one skilled in the art will appreciate that, in operation, the selective rotation of the main rotor of the spool compressor can be configured to cause the guide cam 112 to rotate in unison with other rotational components of the assembly, causing the guide cam slot 100 to act upon guide pin 108. In even further aspects, the valve barrel 106 and other rotational components can be configured to follow a particular rotational pattern.

In other aspects of the disclosure, the rotary injection valve barrel 106 can have at least two passages cut into its outer circumference to allow fluid to pass from one zone to another. In one aspect, the rotary injection valve further comprises a first working chamber and a second working chamber and the at least two passages are configured to allow fluid communication between the first working chamber and the second working chamber upon rotational alignment. As shown in FIG. 3, the valve barrel 106 can have at least one inlet passage 114 and at least one outlet passage 116. In operation, the at least one inlet passage 114 and at least one outlet passage 116 can create a path that changes as the valve barrel 106 is rotated within its valve bore 104, thus selectively exposing or closing passages formed in the housing that further communicate with at least one working chamber.

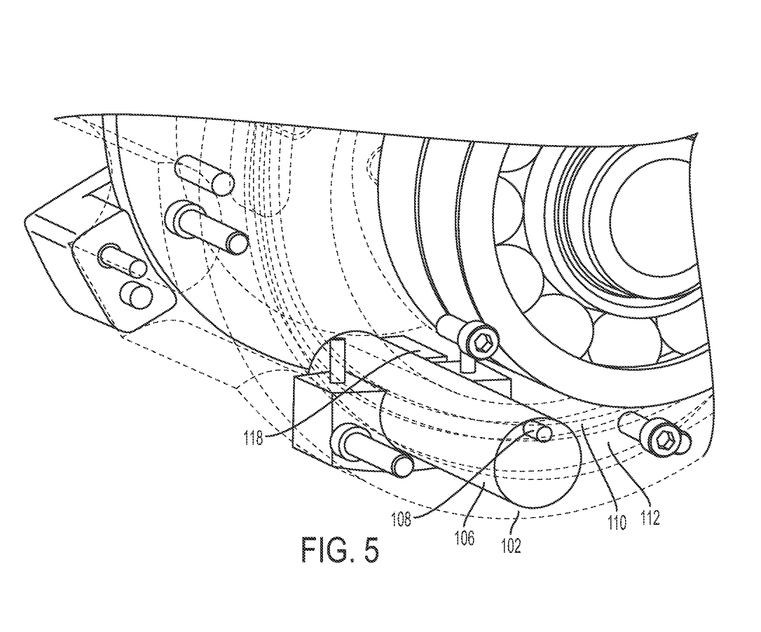

In other aspects and as shown in FIG. 5, rotation of valve barrel 106 within the valve bore 104 can cause the at least one outlet passage 116 to align with at least one housing port 118 formed in housing 102. In one operational aspect, the at least one outlet passage of the rotary injection valve barrel can be aligned with the at least one housing port during at least a portion of the rotation of the valve barrel relative to the valve bore. It is further contemplated that the at least one outlet passage can be aligned with the at least one housing port during a plurality of discrete portions of the rotation of the valve barrel relative to the valve bore. In another operational aspect, fluid can flow along at least one path formed by selective rotational alignment of the at least one inlet passage 114 of the valve barrel 106, the interior chamber of valve barrel 106, exiting the at least one outlet passage 116, the at least one housing port 118, and the working chamber of the compressor assembly provided that a sufficient pressure differential exists between the valve barrel inlet passage 114 and the working chamber of the compressor.

In yet other aspects of the present disclosure, the timing of the at least partial alignment of the at least one outlet passage 116 and the at least one housing port 118 can be chosen such that a fluid can be introduced into the working chamber of the compressor at a specific moment in the process cycle of the compressor and for a chosen duration. In further aspects, the valve outlet passage 116 can be configured to align with the housing port 118 in a plurality of events during a single operational cycle of the compressor allowing a predetermined sequence of fluid passage events to occur. In light of the present disclosure, one skilled in the art will further appreciate that, for a given profile of the guide cam slot 110, a variety of fluid passage events can be achieved through the alignment and subsequent misalignment of valve outlet passage 116 and housing passage 118.

In even further aspects, a plurality of valve outlet passages 116 can be provided in the valve barrel such that they align with a corresponding plurality of housing passages 118 in housing 102 through the selective alignment of said passages 116, 118 achieved through the rotation of valve barrel 106. Here, the at least one path formed by rotational alignment of the corresponding housing and valve assembly features can comprise a plurality of paths that are selectively configured to allow for a desired amount of fluid communication.

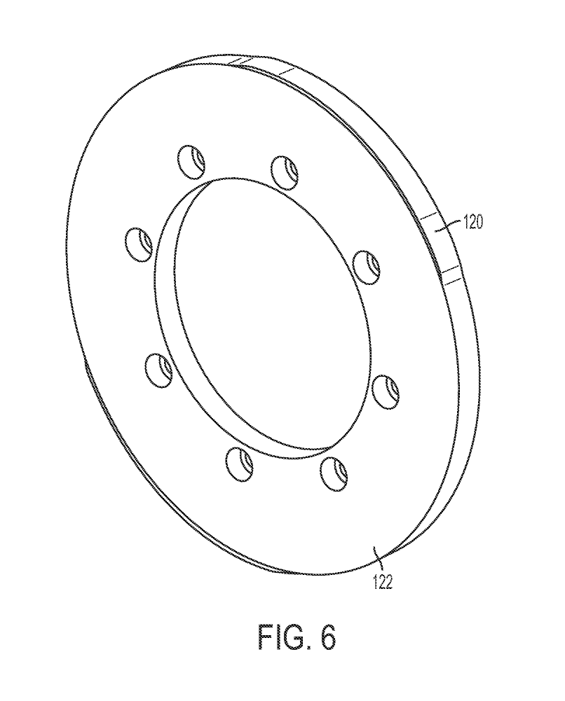

In other aspects of the disclosure and as shown in FIG. 6, the actuating force to rotate the valve barrel 106 can be provided by an external cam profile comprising cam protrusion 120 of peripheral cam 122. Using this configuration, the rotation of valve barrel 106 can be timed for one or more valve opening events per rotation of the rotor to achieve a prescribed fluid flow regimen into or out of the working chamber of the compressor.

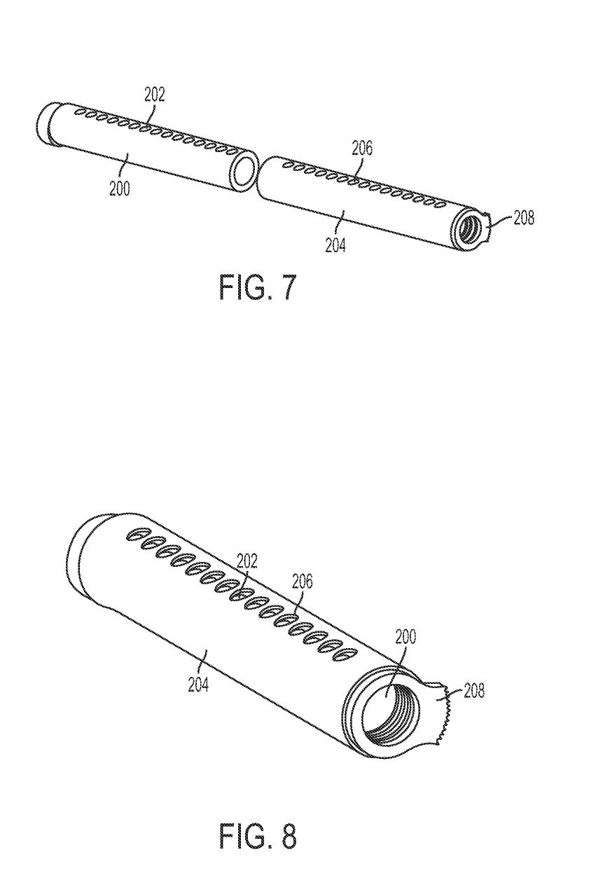

In other aspects of the disclosure and as illustrated in FIG. 7, the fluid flow through the plurality of valve outlet passages 202 can be restricted by a concentric outer valve sleeve 204 that can be configured to shutter the plurality of valve outlet passages 202 when the relative position of valve sleeve 204 is oriented to at least partially close the passages 202 of the valve barrel 200, thereby creating a modulated injection valve. As illustrated in FIG. 8, the assembly comprising the valve barrel 200 inside of the valve sleeve 204 can create a geometric relationship such that the fluid flow exiting the valve barrel can be controlled through the relative position of the plurality of sleeve passages 206 in valve sleeve 204 with regard to the plurality of valve outlet passages 202. Here, the sleeve passages 206 and the valve outlet passages 202 are shown to be circular, but one skilled in the art will appreciate that any chosen geometric profile can be used for these passages, for example and without limitation, oval, square, rectangular, irregular shape, and the like.

In yet other aspects, the motive force for valve sleeve 204 can be provided by a means, for example and without limitation, linkages, gears, gear sets, pulleys, a flexible belt chain drive, direct drive from a motive source, and the like. One exemplary aspect of such a motive force for the valve sleeve 204 comprises a geared tab 208 operable to rotate valve sleeve 204 about is longitudinal axis through the actuation of a mating gear configured to engage with the geared tab 208.

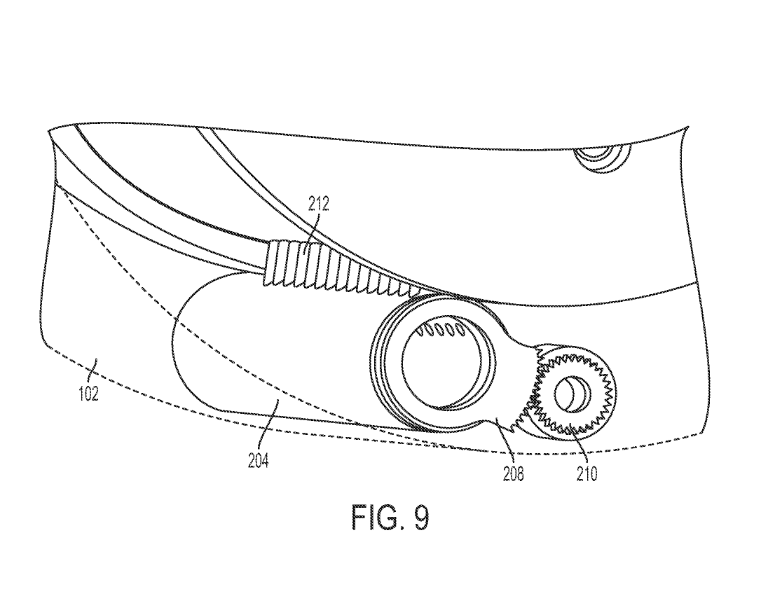

In other aspects of the disclosure and as illustrated in FIG. 9, valve barrel 200 can be rotated by a guide pin 108 as desired using a guide cam 112 (shown in FIG. 5) and simultaneously the valve sleeve 204 can be independently selectively operated by an external motive force acting through gear 210 upon geared tab 208. Here, the valve sleeve 204 can be positioned in a selected relative orientation with valve barrel 200 such that fluid flow through the plurality of outlet passages 202 of rotary injection valve barrel 200 can be restricted by at least one of the relative position of the sleeve ports 206 of valve sleeve 204 and the position of the sleeve ports 206 with respect to corresponding plurality of housing ports 212 provided in housing 102.

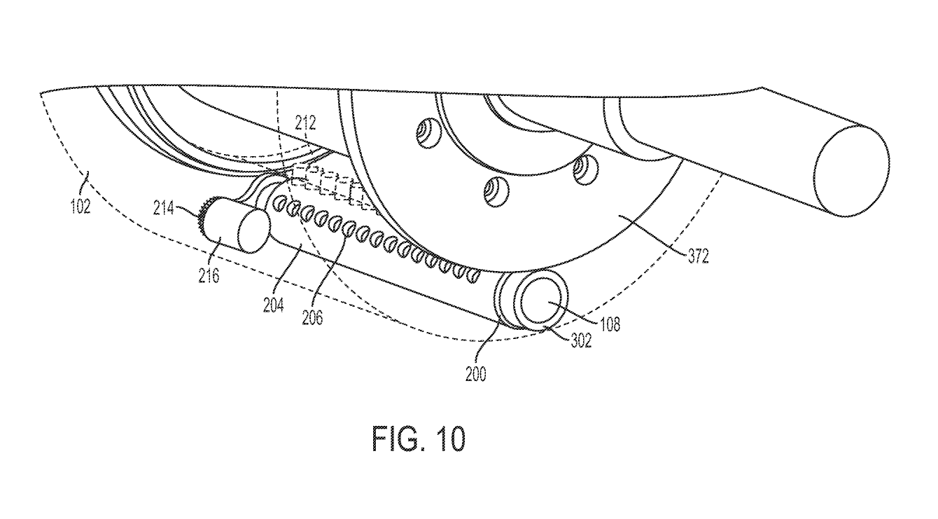

In other aspects of the disclosure and as illustrated in FIG. 10, valve sleeve 204 is shown in a position that completely closes the outlet passages 202 of the rotary injection valve barrel 200. In operation, positional control of the valve sleeve can be achieved by the servo motor 216 (or any other motive means) acting on gear 214 that can engage with the geared tab 208. In light of the present disclosure, one skilled in the art will appreciate that the fluid flow from the rotary injection valve can be selectively and independently controlled to achieve the desired process control of the compressor.

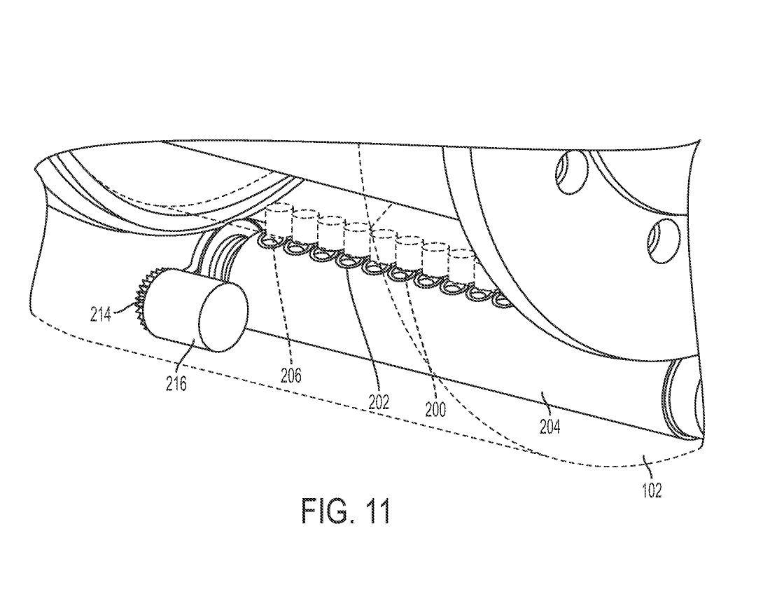

In other aspects of the disclosure and as illustrated in FIG. 11, valve sleeve 204 is shown in a position that only partially closes the rotary injection valve outlet passages 202 so as to restrict but not stop fluid flow through said passages. In operation, the positional control of valve sleeve 204 can be achieved through rotational movement of gear tab 208 as imparted by gear 214 associated with servo motor 216.

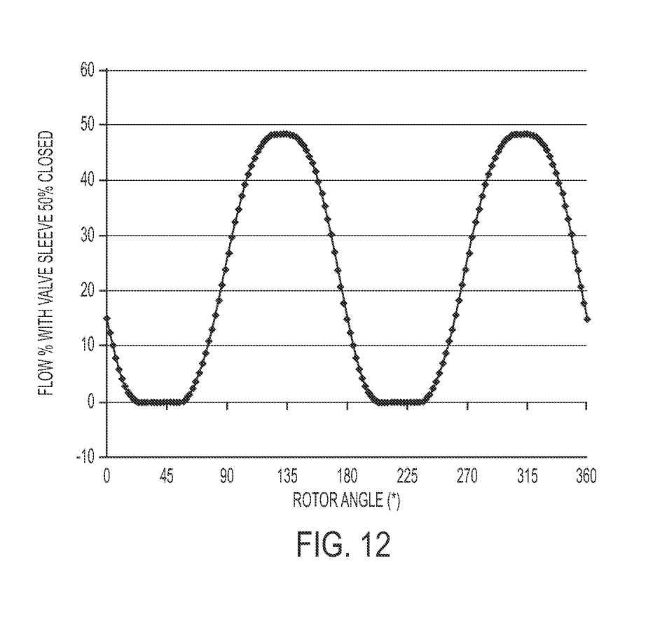

In other aspects of the disclosure and as illustrated in FIG. 12, the relative position of the rotary injection valve barrel with respect to at least one passage provided in the housing can controlled in a cyclical fashion to create the sinusoidal discharge pattern shown. The amount of flow through the rotary injection valve can change as the compressor rotor moves throughout one 360° rotational cycle, the flow being determined by the guide cam slot profile (in the case of the slotted cam shown in FIG. 2), acting on the rotary injection valve barrel 106 through guide pin 108 as described above. In the rotary injection valve flow profile illustrated here, the added throttling of the rotary injection valve flow has been achieved through the use of a valve sleeve where the valve sleeve is positioned relative to the rotary injection valve passages to close the valve passageways to 50% of their fully open flow rate. In light of the present description, one skilled in the art will appreciate that both the timing and the amount of fluid flow can be selectively and independently controlled to achieve the desired performance of the compressor.

In light of the present disclosure one skilled in the art will appreciate that the rotary injection valves described in the present disclosure can be employed advantageously in numerous applications. In some aspects of the present disclosure, the rotary injection valve described herein can be used for the introduction of a selected fluid into an ongoing process within a compressor. In other aspects, the rotary injection valve may be used to off-load pressure created within a working chamber of a pump or compressor. In some other aspects, the rotary injection valve may be used to discharge pressure at one or more selected locations and moments in a process cycle to achieve the desired performance. In yet other aspects, the rotary injection valve may be used to inject a second fluid into a first working fluid of a fluid handling device at selected moments within its process cycle and at selected locations. In further aspects the second fluid injected into the working chamber may be of the same constitution as the first working fluid, but may be in an alternate phase such as selected to affect the performance of the fluidic device through its introduction into the process.

In one exemplary implementation, the rotary injection valves described herein can be further configured as an economizer circuit. For various refrigeration and air conditioning systems, it can be advantageous to inject additional refrigerant gas after the intake port of the compressor has been closed to the system. As one skilled in the art will appreciate, in this type of system the gas from the discharge of the compressor can be divided into a first stream and a second stream subsequent to leaving the compressor. In operation, the first stream can flow to an evaporator to provide heat removal from the secondary medium (i.e., water or air). Here, the second stream can be utilized by an additional heat exchanger to provide additional sub-cooling of the main refrigerant stream thereby increasing the cooling capacity of the main stream in the evaporator. It follows that this second stream must enter the compressor at a point after the main intake of the compressor has been isolated from the system. The rotary injection valve, which is driven by a cam profile in the spool end plate, can be configured to open the injection valve after the tip of the vane is rotationally positioned such that the suction port is no longer exposed to the system. At this rotational position, the compression pocket can be isolated ensuring gas compression is occurring. Depending on the system design and conditions of operation, it can be advantageous to open and close the rotary injection valve at different times and with different durations. thereby changing the amount of gas injected into the machine and the maximum pressure under which it is injected. As one skilled in the art will appreciate in light of the present disclosure, unlike a conventional screw or scroll compressor, the rotary injection valve can be installed at a prescribed physical location and, then, in conjunction with various cam profiles that can be machined into the spool end plate, the maximum and minimum conditions for the pressure and flow profiles can be adjusted to optimize the operating conditions of the unit in which the compressor is installed.

In another exemplary implementation, the rotary injection valves described herein can be further configured to inject liquid refrigerant into a system. Compressors that are used in applications such as low temperature refrigeration in supermarkets can run very high discharge temperatures due to high internal pressure ratios as well as typically highly superheated gas coming to the inlet of the compressor. The spool compressor can utilize a hermetic motor that can be placed in the discharge stream of the compressor and can be subjected to higher gas temperatures than compressors having suction-cooled motors. In order to limit the temperature of the gas and hence the temperature of the motor, liquid refrigerant can be injected into the system. This refrigerant can vaporize and decrease the discharge gas temperature in order to keep the discharge gas temperature within the limits of the maximum temperature of the motor. As one skilled in the art will appreciate in light of the present disclosure, the rotary injection valve here is substantially similar to the valve described above but can be installed in a different radial position around the bore of the machine and located closer to the outlet of the compressor. In other aspects, the rotary injection valve can also be smaller in size since the volume of liquid necessary to achieve a desired cooling effect can be small as a function of the swept volume of the compressor.

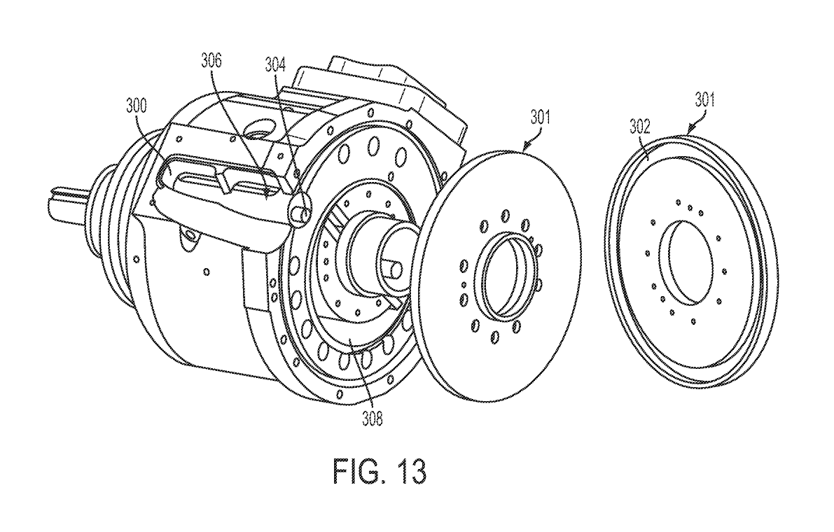

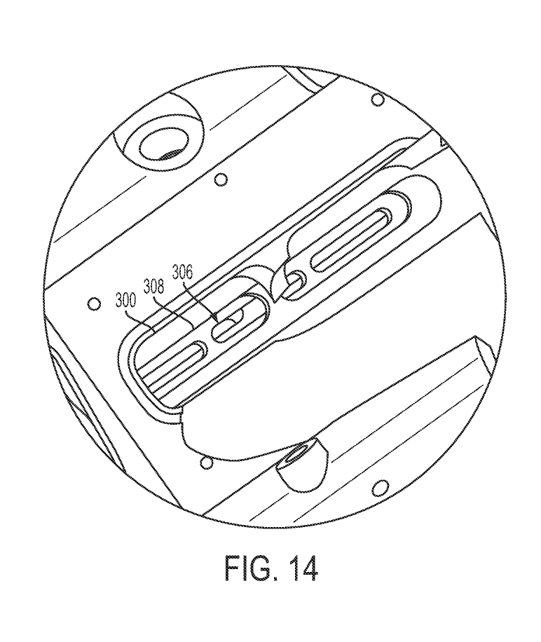

In another exemplary implementation and as shown in FIGS. 13 and 14, the rotary injection valves described herein can be further configured for use in an expander 300. Here, the rotary injection valves can be used to control the flow of high pressure gas into a device configured to expand the gas in order to extract useful work. In this implementation, the cam profile can have a cam groove 302 configured to be mated with a pin 304 that is offset from the center of rotation of the rotary injection valve 306. The profile of the cam groove 302 machined into one side of rotating plate 301 as well as the size and location of the fluidic passages in the rotary injection valve 306 will determine what fraction of a revolution the high pressure gas external to the expansion chamber and the expansion chamber are in fluidic communication. The assembly 300 comprising the cam groove 302 and rotary injection valve 306 can allow for a fixed internal volume ratio of the machine. The internal volume ratio can be defined as:

$${V}_{i} = \frac{{V}_{e}}{{V}_{c}} \qquad ( 1 )$$

where Vₑ and V_{c} are the volume of the internal chambers fully expanded and fully charged, respectively. As one skilled in the art will appreciate, the operation of the expander will typically be the most efficient when the operating conditions are such that the system pressures allow the expander to operate at this internal volume ratio. In other words, the incoming gas is not over-expanded or under-expanded as it travels through the expander.

In a further aspect, a volume adjustment valve 308 can be placed surrounding the rotary injection valve 306. The volume adjustment valve 308 can be controlled external to the rotating mechanism by means of a separate electro-mechanical system such as, for example and without limitation, a servo motor or the like. In operation, the articulation of the volume adjustment valve 308 can enable the variation of the internal volume ratio during the operation of the expander 300 by changing the charge volume. By adjusting the volume adjustment valve to reduce the amount of time the rotary valve and the expansion process are in fluidic communication, the charge volume can be increased. As evidenced by Equation (1), increasing the charge volume decreases the internal volume ratio. The inverse also applies. Since the operating conditions dictate the optimum operating internal volume ratio, the volume adjustment valve can allow real-time adjustment of the expander and enable operation continuously at the optimum internal volume ratio.

In yet further aspects of the present disclosure, any one of the valve elements as described herein can be implemented simultaneously in a given device.

In another aspect, one method for operating a system comprising a rotary injection valve comprises (i) providing a spool compressor comprising a main rotor and a housing having at least one housing port that communicates with a corresponding at least one working chamber and a valve bore formed therein, a rotary injection valve having a valve barrel associated with a valve bore, a valve barrel longitudinal axis and inlet passage and an outlet passage, wherein the rotary injection valve further comprises a guide pin located parallel to but in a non-concentric location with respect to the valve barrel longitudinal axis, and a guide cam having a guide cam slot configured to engage and apply a lateral force to the guide pin, (ii) causing the valve barrel to rotate about the valve barrel longitudinal axis; causing the main rotor to rotate the guide cam in unison along a prescribed rotational pattern with other rotational components of the assembly and to act upon the guide pin, wherein the inlet passage and the outlet passage of the valve barrel rotate to selectively expose or close at least one housing port that communicates with a corresponding at least one working chamber. Providing a sufficient pressure differential between the valve barrel inlet passage and the at least one working chamber can ensure that fluid can flow through the inlet passage of the valve barrel, through the interior chamber of the valve barrel, exiting through the outlet passage, through the at least one housing port to the corresponding at least one working chamber.

In an alternate aspect, one method for operating a system comprising a modulated rotary injection valve further comprises providing a concentric outer valve sleeve configured to shutter the inlet passage and outlet passage of the valve barrel, and providing a means for selectively controlling the position of the valve sleeve.

In an alternate aspect, one method for operating a system comprising a rotary injection valve adapted as an economizer circuit can operate substantially as described above with the following modifications: providing a cam profile operable to cause the rotary injection valve to open when the inlet port (or suction port) is no longer exposed to the system.

In another alternate aspect, one method for operating a system comprising a rotary injection valve adapted as an expander can operate substantially as described above with the following modifications: providing a cam groove profile and a rotary injection valve having a plurality of \passages configured to open a selected fraction of a revolution in order to place the high pressure gas external to the expansion chamber and the expansion chamber in fluidic communication.

The present disclosure can thus be embodied in other specific forms without departing from its spirit or essential characteristics. The described aspects are to be considered in all respects only as illustrative and not restrictive. The scope of the present disclosure is, therefore, indicated by the appended claims rather than by the foregoing description. All changes that come within the meaning and range of equivalency of the claims are to be embraced within their scope.

What is claimed is:

1. An apparatus comprising:
a housing having a valve bore defined therein,
a rotary injection valve comprising a valve barrel rotatably received therein the valve bore and a valve barrel longitudinal axis, wherein the rotary injection valve further comprises a guide pin located parallel to but in a non-concentric location with respect to the valve barrel longitudinal axis, and
a guide cam defining a guide cam slot that is configured to selectively engage and apply a lateral force to the guide pin to cause the valve barrel to selectively rotate about the valve barrel longitudinal axis.

2. The apparatus of claim 1, wherein the rotary injection valve barrel further comprises at least two openings defined therein.

3. The apparatus of claim 2, wherein the rotary injection valve further comprises a first working chamber and a second working chamber, and wherein the at least two openings are configured to allow fluid communication between the first working chamber to the second working chamber.

4. The apparatus of claim 3, wherein the at least two openings further comprises at least one inlet passage and at least one outlet passage.

5. The apparatus of claim 4, wherein, upon rotation of the valve barrel relative to the valve bore, at least one path configured for fluid communication is defined by the at least one inlet passage and the at least one outlet passage.

6. The apparatus of claim 5, wherein the at least one path comprises a plurality of paths that are selectively configured to allow for a desired amount of fluid communication.

7. The apparatus of claim 6, wherein the at least one inlet passage and the at least one outlet passage are further configured to selectively expose and cover a plurality of passages defined in the housing that further communicate with at least one working chamber.

8. The apparatus of claim 6, wherein the housing further comprises at least one housing port defined therein.

9. The apparatus of claim 8, wherein the at least one outlet passage of the rotary injection valve barrel is aligned with the at least one housing port during at least a portion of the rotation of the valve barrel relative to the valve bore.

10. The apparatus of claim 9, wherein the at least one outlet passage of the rotary injection valve barrel is aligned with the at least one housing port during a plurality of discrete portions of the rotation of the valve barrel relative to the valve bore.

11. The apparatus of claim 6, further comprising a concentric outer valve sleeve operable to selectively shutter the at least one outlet passage during at least a portion of the rotation of the valve barrel relative to the valve bore.

12. The apparatus of claim 11, further comprising a means for applying a motive force to the concentric valve outer sleeve.

13. The apparatus of claim 12, wherein the means for applying the motive force comprises at least one of at least one linkage, at least one gear, a gear set, at least one pulley, a flexible belt, a chain drive, and a direct drive coupled to a motor.

14. The apparatus of claim 12, wherein the valve barrel is rotated by a guide pin coupled to a guide cam and a valve sleeve is independently selectively operated by a gear acting upon a geared tab.

15. The apparatus of claim 6, wherein the relative position of the rotary injection valve barrel with respect to the at least one housing port can be controlled cyclically to create a discharge pattern.

16. The apparatus of claim 15, wherein the discharge pattern is sinusoidal.
